(19) United States
(12) Patent Application Publication
(10) Pub. No.: US 2010/0015547 A1
(43) Pub. Date: Jan. 21, 2010

(54) METHOD FOR PRODUCING ELECTROSTATIC IMAGE DEVELOPING TONER

(75) Inventors: Shuangquan ZHU, Wuhan (CN); Zeguan LAN, Wuhan (CN); Liping LU, Wuhan (CN)

Correspondence Address: MATTHIAS SCHOLL, 14781 MEMORIAL DRIVE, SUITE 1319, HOUSTON, TX, 77079, US

(73) Assignee: HUBEI DINGLONG CHEMICAL CO., LTD., Wuhan (CN)

(21) Appl. No.: 12/203,224

(22) Filed: Sep. 3, 2008

(30) Foreign Application Priority Data
Jul. 17, 2008 (CN) 200810048434.3

(51) Int. Cl. G03G 5/00

(52) U.S. Cl. 430/137.1

(57) ABSTRACT

Provided is a method for producing an electrostatic image developing toner comprising: agglutinating wax and resin particles in aqueous medium; manufacturing a toner composed of wax and resin for developing an electrostatic image, wherein the wax is inside colorants. The method solves the problems of existing toner for developing an electrostatic image, such as low dispersion and easy detachment of colorants, low image density, the contamination of carriers and developing sleeves and low durability. The toner of the invention has high roll viscosity resistance and durability, and the colorants will not detach.

### CROSS-REFERENCE TO RELATED APPLICATIONS

This application claims priority to Chinese Patent Application No. 200810048434.3 filed on Jul. 17, 2008. The contents of which are incorporated herein by reference.

### BACKGROUND OF THE INVENTION

1. Field of the Invention

The invention relates to a method, and more particularly to a method for producing an electrostatic image developing toner.

2. Description of the Related Art

The most widely used method for producing a toner in electrophotography comprises melt-blending a colorant composed of a dye and carbon black, a releasing agent composed of wax into a styrene acrylic resin or polyester resin to form a uniform dispersion, pulverizing the blended matter, and classifying the pulverized matter to separate toner particles having an intended particle size. However, the particle size of the obtained toner according to above method has limitation. To obtain high yield of particles with diameter less than 10 μm, especially less than 8 μm is very difficult. Thus the conventional method can not meet the requirement of high resolution in future electrophotography.

Additionally, dispersing wax with low softening point in a toner during melt-blending is the general method of oil-free fixation. In current melt-blending/pulverizing method, if more wax is contained, it will detach away during pulverizing. Surplus wax still exists on the toner surface to cause the contamination of carriers and development sleeves, or the curtailment of longevity. Moreover, filming formed on a photoreceptor by wax can cause image defect. Furthermore, due to wax detachment, the original goal of fixation under low temperature can not exhibit completely.

In Japanese patent publication No. 63-186253, in order to overcome the problem of particle size control and reach high resolution, disclosed is to manufacture a toner by emulsion polymerization/agglutination. However, the method is to agglutinate resin particles, wax particles and colorants. If much more wax is contained, it will detach, as mentioned before, causing the contamination of carriers and development sleeves or filming forming on the photoreceptor by wax. All these can not ensure the durability of a toner.

In Japanese patent publication No. 2001-27821, disclosed is a method for manufacturing a tone by agglutinating colorants and polymer particles, wherein wax particles are used as the seeds. According to the method, since more wax can be contained in a toner, it is a good way to improve fixation characteristics. However, the colorants are dispersed at a low degree, and the image density cannot be enhanced. Furthermore, the colorants detach easily, resulting in the contamination of carriers or developing sleeves, as well as lower durability.

### SUMMARY OF THE INVENTION

It is an objective of the invention to provide a method for producing an electrostatic image developing toner featuring high roll viscosity resistance and durability.

The inventor has found that the above-mentioned problems can be solved by preparing polymer particles agglutinating colorants with inner wax and resin particles in aqueous medium.

In the invention, since colorants exist in wax, by agglutinating resin particles and colorants with inner wax, a toner contains both wax and colorants and detachment of colorants will not occur.

Furthermore, in a case that wax exists in the vicinity of high polarity colorants, the colorants appear in the toner, and thus no colorant pollution will occur on a fixation position, and stable image can be guaranteed even after a long period of use.

To achieve the above objectives, in accordance with one embodiment of the invention, provided is a method for producing an electrostatic image developing toner comprising agglutinating wax and resin particles in aqueous medium and manufacturing an electrostatic image developing toner comprising wax and resin, wherein the wax is disposed within colorant.

The wax of the invention can be any kind of well-known wax, olefin wax such as low molecular weight polyethylene, low molecular weight polypropylene and copolymerized polyethylene; hydrocarbons wax such as paraffin or microcrystalline wax; long-chain aliphatic-based ester wax such as docosanoic acid docosyl ester, lignite acid docosyl ester, stearic acid stearyl and pentaerythritol tetrabehenate; natural wax such as carnauba wax, beeswax; higher fatty acid amide such as oleic acid amide, stearic amide. In order to improve fixation performance under low temperature, the melting point of wax is below 100° C., preferably 40-90° C., and most preferably 60-85° C. If the melting point is over 100° C., the fixation performance under low temperature will decrease.

The colorant of the invention can be any kind of inorganic pigments, organic pigments or organic dyes, or a combination thereof. Specific examples are black colorants: carbon black, magnetite, titanium black, aniline black, aniline black dyestuffs; cyan colorants: pigment blue 15:3, pigment blue 15:4, etc.; yellow colorants: pigment yellow 14, pigment yellow 17, pigment yellow 93, pigment yellow 94, pigment yellow 138, pigment yellow 150, pigment yellow 155, pigment yellow 180, pigment yellow 185, solvent yellow 19, solvent yellow 44, solvent yellow 77, solvent yellow 162, etc.; magenta colorants can be pigment Red 5, pigment red 48:1, pigment red 48:2, pigment red 48:3, pigment red 53:1, pigment red 57:1, pigment red 122, etc.

Since colorants have high polarity, in order to disperse colorants among wax, polarity wax is preferable.

Based on above point, ester wax is a good choice. If non-polarity carbohydrate wax such as paraffin is used, due to its low polarity, there will be low affinity force between wax and colorants. Mixing with ester wax is a good way of regaining polarity.

The colorant added is 1 to 40 parts by weight, and more preferably 2 to 30 parts by weight based on 100 parts by weight of an adhesive resin. The wax added is 3 to 20 parts by weight based on 100 parts by weight of the adhesive resin.

In order to disperse the colorants among wax, the following steps can be used. The mixture of wax and colorants is melt-blended in dry melt-blending equipment, such as a two-axes extruder, a two-roll mill or a three-roll mill, etc. After that, to disperse the melt-blended mixture in aqueous medium and colorants with inner wax are obtained. Optionally, there is another way: to melt wax into liquid and add colorants, then to disperse the mixture by a sand mill or a SC mill at the presence of liquid, further to disperse the above liquid-dispersed mixture in aqueous medium, and colorants with inner wax are available.

In order to disperse the colorants with inner wax of the invention stably in aqueous medium, the wax mentioned above can be dispersed and prepared in aqueous medium with the presence of at least a surfactant. The surfactant can be selected among the known cationic surfactants, anionic surfactants and non-ionic surfactants. Two or more kinds of these surfactants can be used together. Specific examples of the cationic surfactants are dodecyl ammonium chloride, dodecyl ammonium bromide, dodecyltrimethyl ammonium bromide, dodecyl pyridyl chloride, dodecyl pyridyl bromide and cetyltrimethyl ammonium bromide, etc.

Specific examples of the anionic surfactants are sodium stearate, sodium laurate, sodium dodecyl sulfate, sodium dodecyl benzene sulfonate, sodium dodecyl sulfate, and other metal salts of higher fatty acid, etc.

Specific examples of the non-ionic surfactants are: poly(oxyethylene)dodecy ether, poly(oxyethylene)hexadecyl ether, poly(oxyethylene)nonyl-phenyl ether, poly(oxyethylene)lauryl ether, sorbitan mono-oleate poly(oxyethylene)ether, monodecanoate sucrose, etc.

In the presence of surfactants, an emulsion for seed polymerization is obtained through dispersing the wax. The average particle diameter of the wax emulsion is between 10-1000 nm, preferably in the range of 30-500 nm. The average particle diameter is determined by LS230 (manufactured by Beckman Coulter, Inc.).

If the average particle diameter of the wax emulsion is over 1000 nm, the average particle diameter of polymer particles formed by seed polymerization will be too large. While pulverizing, it is difficult to narrow the particle diameter distribution and obtain small toner particles. In addition, when the average particle diameter of the wax emulsion is smaller than 10 nm, the amount of wax in the polymer particles formed by seed polymerization is easy to diminish. Further, it is possible to cause the lower effect of roll viscosity resistance property during low temperature fixation.

The method for dispersing colorants with inner wax is not limited to this, for example, a high-speed rotating device such as a clearmix (a disperser manufactured by M technique Co.) can be used. A TK homogenizer (manufactured by PRIMIX Co.) can also be used. Besides, a SC mill (a pulverizer manufactured by Mitsui Mining Co., Ltd.) or a sand mill can also be used.

In dispersing the colorants with inner wax, a good way is to heat the wax above the melting point, then to disperse the wax in aqueous medium.

In order to prepare resin particles, free radical polymerisable monomer can be agglutinated in aqueous medium. Optionally another way of preparing resin particles is to disperse resin solution originated from melted resin in solvent, and then to remove solvent. Compared with polymerization in aqueous medium, it is environment-friendly because the method of preparing resin particles does not contain solvent.

The free radical polymerisable monomers of the invention can be styrene type, such as styrene, α-methyl styrene, chlorine styrene, dichlorostyrene, p-tert-butyl styrene, p-n-butyl styrene, p-n-nonyl styrene, or acrylate ester such as methyl acrylate, ethyl acrylate, propyl acrylate, butyl acrylate, iso-butyl acrylate, 2-hydroxyethyl acrylate, ethylhexyl acrylate, methyl methacrylate, ethyl methacrylate, propyl methacrylate, butyl methacrylate, iso-butyl methacrylate, hydroxyethyl methacrylate, ethylhexyl methacrylate, etc. The preferable monomer is styrene and butyl acrylate.

Polarity-based free radical polymerisable monomer can be used. Acid-polarity based monomer can be carboxylic-based radical polymerizable monomer, such as acrylic acid, methacrylate, maleic acid, fumaric acid, cinnamic acid, and sulfonic-based free radical polymerisable monomer, such as sulfonated styrene. The preferable monomer is acrylic acid or methacrylic acid.

Alkaline-polarity based free radical polymerisable monomer comprises nitrogen heterocyclic ring polymerisable monomer such as amino styrene and quaternary salt thereof, vinyl pyridine, vinylpyrrolidone, amino-based acrylic ester such as dimethylamino ethyl acrylate, diethylamino ethyl methacrylate, and those quaternary amino acrylate esters containing ammonium salt (meta), acrylamide, N-propyl acrylamide, N,N-dimethyl acrylamide, N,N-dipropyl acrylamide, N,N-dibutyl acrylamide, acrylamide, etc.

These free radical polymerisable monomers can be used alone or in combination with other materials, and the glass transition temperature of polymer is preferably between 40° C. and 70° C. If the glass transition temperature is over 70° C., fixing temperature is too high, and the fixation property will decrease; on the other hand, if the glass transition temperature is below 40° C., the preservation stability of toner decreases, and aggregation occurs.

The polymerisable initiators can be water soluble persulfate, such as potassium persulfate, sodium persulfate, ammonium persulfate, and redox polymerization initiators composed of above-mentioned persulfates and reducing agents such as acid sodium sulfite or ascorbic acid. Moreover, the polymerisable initiators can also be water soluble initiators, such as hydrogen peroxide, 4,4′-Azobis (4-cyanovaleric acid), tert-butyl hydroperoxide, cumene hydroperoxide, and redox polymerization initiators composed of above-mentioned water-soluble polymerization initiators and reducing agents such as ferrous salt or ascorbic acid. These polymerisable initiators can be added to polymerization system before, simultaneously or any time after radical polymerisable monomer is added. These adding methods can be used combinedly dependent on situation.

In order to adjust the molecular weight of polymer of the invention, a chain transition agent can be used when necessary. Specific examples of the chain transition agent are t-dodecyl mercaptan, n-dodecyl mercaptan, 2-mercapto ethanol, diisopropyl xanthogen, carbon tetrachloride, trichloromethyl bromide, etc. The chain transition agent can be used alone, or combined by two and more. Based on the amount of free radical polymerisable monomer, the largest amount of free radical polymerizable monomer is preferably not more than 5% by weight. When the amount is excessive, with decrease of molecular weight, the residue of radical polymerisable monomer will increase. That will result in sharp smell.

The average particle diameter of resin particles is preferably between 50-1500 nm, more preferably 70-700 nm. The average particle diameter can be determined by LS230 (manufactured by Beckman Coulter Co.). When the average particle diameter is lower than 50 nm, the problem of image defect or low releasing effect will occur due to low wax content. In addition, if the diameter is larger than 1500 nm, control of the toner particle diameter will be difficult, and the particle size range will accordingly be wide.

In the invention, a charge control agent can be added into the toner. The charge control agent can be any well-known material. These materials can be used alone or in combination with other materials. The preferable positive charge is quaternary amine salt, and the preferable negative charge is salicylic acid or alkyl salicylic acid metal salt and metal complex thereof, benzoic acid metal salt and metal complex thereof, amino compounds, phenol compounds, naphthol compounds, aminophenol compounds, etc. The above-mentioned metal can be chromium, zine, aluminium. The amount of the charge control agent is determined by the expected electric charge of the toner. If the binding resin is 100 parts by weight, the charge control agent is preferably between 0.01 and 10 parts by weight, more preferably between 0.1 and 10 parts by weight.

A preferable method of adding the charge control agent is to disperse the agent into particles in aqueous medium and to agglutinate the particles with colorants and resin particles.

The method of agglutinating colorants with inner wax and resin particles are described as follows: dispersion solution of colorants with inner wax is mixed with dispersion solution resin particles; heating or adjusting pH value of the mixture makes the dispersion unstable, and then agglutinating and heating for fusion, or adding agglutinating salt for agglutination and then heating for fusion. An optional way is to disperse colorants with inner wax and resin particles by surfactants having different polarity, then to agglutinate the mixture quickly. Particularly, adding agglutinating salt is a good way because the method can form a stable agglutinating state.

In order to obtain agglutinating salt, univalent or multivalent metal salts are used. Specifically, univalent metal salts can be sodium salt and potassium salt, such as sodium chloride, potassium chloride, etc; bivalent metal salts can be magnesium chloride, magnesium sulfate, calcium chloride, calcium sulfate, etc; trivalent metal salts can be aluminum hydroxide, aluminum chloride, etc.

In agglutinating colorants with inner wax with resin particles by heating fusion, the agglutinating salt is added below the glass transition temperature of polymer particles, and then to heat as quickly as possible to improve the glass transition temperature of the polymer particles. The preferable time of raising temperature is within one hour. Moreover, the raise of temperature must be rapid, and heating rate is preferably more than 0.25° C./min. The upper limit is not definite, but if the temperature rises instantaneously, the salting out will occur dramatically, and it will be very difficult to control the particle size. Thus, the preferable rate is below 5° C./min. By fusion, the polymer particles and the dispersion solution of the polymer particles are obtained.

Subsequently, by filtrating and rinsing, colorant particles are separated from aqueous medium. The method of filtrating and rinsing can be centrifugal separation, vacuum filtration by a suction filter or similar method by a filter press.

After the rinsed colorant particle cake is dried, dried colorant particles are obtained. The dryer can be a spray dryer, a vacuum freeze dryer or a vacuum dryer, preferably a static shed dryer, a mobile shed dryer, a fluid layer dryer, a rotary dryer or a stirring dryer. The water content of the dried colorant particles is preferably below 5% by weight, more preferably below 2% by weight. In addition, when the dried colorant particles are agglutinated by relatively weak attractive force between particles, the agglutination group can be pulverized. The pulverizing device can be a jet mill, a Henshel mixer, a coffee mill, a food processing machine or other mechanical pulverizing device.

During preparing the toner of the invention, when the particle diameter of agglutinating particle has virtually grown into the expected particle size, a same or different kind of adhesive resin emulsion can be added to make the particles adhered to the surface so as to modify the toner property around the surface.

In the invention, additives such as a flowable agent can be added in the toner when necessary. The flowable agent can be hydrophobic silicon dioxide, titanium dioxide, alumina and other micro powder. The amount of the flowable agent is usually 0.01-5 parts by weight based on 100 parts of adhesive resins, preferably 0.1-3 parts. The average particle diameter of these flowable agents is preferably 5 to 80 nm.

Inorganic micro powder such as magnetite, ferrite, cerium oxide, and strontium titanate, conductive titanium dioxide, or resistance regulator, slip agent such as styrene resin, acrylic resin, etc. can be added as an internal additive or an external additive when preparing the toner. The amount of these additives is determined in accordance with expected performance, preferably 0.05-10 parts by weight based on 100 parts of adhesive resins.

The relatively big particle size of additives is preferable, and the average particle diameter is 100-1000 nm.

The electrostatic image developing toner of the invention can be used as a two-component developer or a non-magnetic one-component developer. When used as a two-component developer, carriers can be magnetic materials, such as iron powders, magnetite powders, ferrite powders etc., or other well-known materials having resin coating on the surface thereof and magnetic carriers. The cover resin of resin coating carriers can be styrene resin, acrylic resin, styrene-acrylic acid copolymer resin, silicone resin, modified silicone resin, fluorine resin, or combinations thereof.

### DETAILED DESCRIPTION OF THE INVENTION

### EXAMPLE 1

### For Preparing Colorants with Inner Wax

30 parts by weight of docosanoic acid docosyl ester and 15 parts by weight of carbon black are melt-blended in a two-mill roller, after cooling, particles of wax with dispersed carbon black are obtained. 30 g of the particles are melted at 80° C., and wax-carbon black dispersion solution is prepared. Subsequently, the dispersion solution is added into 300 g of 5% sodium dodecyl benzene sulfonate solution at 80° C. The solution is dispersed by CLEAMIX and the particle size is determined by LS230 (manufactured by Beckman Coulter Co.), until the average particle diameter reaches 230 nm. The dispersion solution of colorants with inner wax is named Bk1.

### EXAMPLE 2

### For Preparing Colorants with Inner Wax

The preparation process is the same as in Embodiment 1, the only difference is the part of docosanoic acid docosyl ester is 40 by weight. The average particle diameter is 220 nm. The dispersion solution of colorants with inner wax is named Bk2.

### EXAMPLE 3

### For Preparing Colorants with Inner Wax

The preparation process is the same as in Embodiment 1, the only difference is the raw material of docosanoic acid docosyl ester is replaced by carnauba wax. The average particle diameter is 230 nm. The dispersion solution of colorants with inner wax is named Bk3.

### EXAMPLE 4

### For Preparing Colorants with Inner Wax

The preparation process is the same as in Embodiment 1, the only difference is the raw material of docosanoic acid docosyl ester is replaced by pentaerythritol tetrabehenate. The average particle diameter is 240 nm. The dispersion solution of colorants with inner wax is named Bk4.

### EXAMPLE 5

### For Preparing Colorants with Inner Wax

The preparation process is the same as in Embodiment 1, the only difference is the raw material of carbon black is replaced by pigment yellow 74. The average particle diameter is 220 nm. The dispersion solution of colorants with inner wax is named Y1.

### EXAMPLE 6

### For Preparing Colorants with Inner Wax

The preparation process is the same as in Embodiment 1, the only difference is the raw material of carbon black is replaced by pigment red 122. The average particle diameter is 240 nm. The dispersion solution of colorants with inner wax is named M1.

### EXAMPLE 7

### For Preparing Colorants with Inner Wax

The preparation process is the same as in Embodiment 1, the only difference is the raw material of carbon black is replaced by pigment blue 15:3. The average particle diameter is 240 nm. The dispersion solution of colorants with inner wax is named C1.

### EXAMPLE 1

### For Preparing a Toner

800 g of 5% sodium dodecyl benzene sulfonate and 1.2 g of potassium persulfate as water-soluble polymerization initiator are added respectively into a glass reaction vessel. The reaction vessel comprises a stirring device, a heating-cooling device, a concentration device and an inlet for materials. After the vessel is heated up to 85° C., monomer solution comprising 70 g of styrene, 20 g of butyl acrylate and 10 g of butyl acrylate is instilled within one hour for emulsion polymerization. 7 hours later, the reaction is terminated and the polymer is cooled down to 20° C. The particle diameter is determinated to be 190 nm. Subsequently, the dispersion solution of colorants with inner wax Bk1 is added, and 300 g of 20% magnesium chloride solution is instilled while stirring within 30 minutes at 30° C. Then the temperature is raised to 80° C. The growth of the particle diameter is monitored. When the particle diameter (median size of volume base: determined by Kurt Multi sizer II manufactured by Beckman Coulter) reaches 6.5 μm, 300 g of sodium chloride solution is added to inhibit the particle diameter growth. When the temperature rises to 95° C., spherical shape particles form gradually within 5 hours. After the shape coefficient reaches 0.965 (determined by FPIA-3000), the temperature is lowered to 20° C. Subsequently, the particles are filtrated by a centrifugal separator, rinsed by water, and dried by a vacuum dryer. 2 g of hydrophobic silicon dioxide (treated with Hexamethyldisilazane, the average particle diameter is 12 nm) and 1 g of hydrophobic titanium dioxide (treated with Octyltrimethyl silane, the average particle diameter is 25 nm) are added into 200 g of the dried particles. Finally, the mixture is blended by a Henshel mixer. The obtained toner is named toner Bk1.

### EXAMPLE 2

### For Preparing a Toner

The preparation process is the same as in Embodiment 1 for preparing a toner, the only difference is the dispersion solution of colorants with inner wax Bk1 is replaced by the dispersion solution of colorants with inner wax Bk2. The obtained toner is named toner Bk2.

### EXAMPLE 3

### For Preparing a Toner

The preparation process is the same as in Embodiment 1 for preparing a toner, the only difference is the dispersion solution of colorants with inner wax Bk1 is replaced by the dispersion solution of colorants with inner wax Bk3. The obtained toner is named toner Bk3

### EXAMPLE 4

### For Preparing a Toner

The preparation process is the same as in Embodiment 1 for preparing a toner, the only difference is the dispersion solution of colorants with inner wax Bk1 is replaced by the dispersion solution of colorants with inner wax Bk4. The obtained toner is named toner Bk4.

### EXAMPLE 5

### For Preparing a Toner

The preparation process is the same as in Embodiment 1 for preparing a toner, the only difference is the dispersion solution of colorants with inner wax Bk1 is replaced by the dispersion solution of colorants with inner wax Y1. The obtained toner is named toner Y1.

### EXAMPLE 6

### For Preparing a Toner

The preparation process is the same as in Embodiment 1 for preparing a toner, the only difference is the dispersion solution of colorants with inner wax Bk1 is replaced by the dispersion solution of colorants with inner wax M1. The obtained toner is named toner M1.

### EXAMPLE 7

### For Preparing a Toner

The preparation process is the same as in Embodiment 1 for preparing a toner, the only difference is the dispersion solution of colorants with inner wax Bk1 is replaced by the dispersion solution of colorants with inner wax C1. The obtained toner is named toner C1.

### EXAMPLE 1

### For Preparing a Comparative Toner

Based on embodiment 1 of preparing a toner, the dispersion solution of colorants with inner wax Bk1 is replaced by comparative dispersion solution Bk1. The comparative dispersion solution Bk1 is prepared as follows: 8 g of carbon black is added into 50 g of 50% sodium dodecyl benzene sulfonate solution, and then the mixture is dispersed at 30° C. by CLEAMIX until the average particle diameter reaches 80 nm. 20 g of melted docosanoic acid docosyl ester at 80° C. is added into 200 g of 5% sodium dodecyl benzene sulfonate solution at 80° C. Subsequently the mixture is dispersed by CLEAMIX until the average particle diameter reaches 200 nm (the dispersion solution is comparative wax 1). The comparative dispersion solution Bk1 is mixed with the comparative wax 1. The following steps are the same as in embodiment 1 of preparing a toner. The obtained toner is named comparative toner 1.

### EXAMPLE 2

### For Preparing a Comparative Toner

The preparation process is the same as in Embodiment 1 for preparing a comparative toner, the only difference is carbon black is replaced by pigment yellow 74. The obtained toner is named comparative toner 2.

### EXAMPLE 3

### For Preparing a Comparative Toner

The preparation process is the same as in Embodiment b 1 for preparing a comparative toner, the only difference is carbon black is replaced by pigment fuchsin 122. The obtained toner is named comparative toner 3.

### EXAMPLE 4

### For Preparing a Comparative Toner

The preparation process is the same as in Embodiment 1 for preparing a comparative toner, the only difference is carbon black is replaced by pigment blue 15:3. The obtained toner is named comparative toner 4.

Evaluation

To evaluate the fixation (roll viscosity resistance) and durability of above-mentioned toners.

The toners are evaluated by a non-magnetic one-component printer. The printer is ColorLaserJet 2605 manufactured by HP Inc.

Evaluation on Roll Viscosity Resistance

Under low temperature and low humidity (10° C./10% RH), 1000 sheets of stipple pattern (full pixel rate is 40% halftone image) are continuously printed. The pixel rate of yellow/magenta/green/black is 10%. Then shut off power for a night. In the next morning, observe the fixing part visually whether the toner leaks or not.

Evaluation on Durability

Under high temperature and high humidity (33° C./85% RH), 4000 sheets of stipple pattern are continuously printed under one piece intermittent mode (that is, pause for 10 seconds after each sheet is printed). The pixel rate of yellow/magenta/cyan/black is 1%. By comparing with paper reflection density which is [0], the imaging density (black) of the initial image and the 4,000th image are obtained respectively. Likewise, the fog density of the initial image and the 4,000th image are obtained. After that, compare the color gamut formed by Y/M/C and B/G/R under full-color visual observation. The concrete method is to set the color gamut area of the initial image as 100, and the 4,000th image is compared with the initial image, then the color gamut area of the 4,000th image is calculated.

The following toner combinations are used:

Embodiment 1: toner Bk1/toner Y1/toner M1/toner C1

Embodiment 2: toner Bk2/toner Y1/toner M1/toner C1

Embodiment 3: toner Bk3/toner Y1/toner M1/toner C1

Embodiment 4: toner Bk4/toner Y1/toner M1/toner C1

Comparative embodiment 1: comparative toner 1/comparative toner 2/comparative toner 3/comparative toner 4

Evaluation Results

| | Whether leakage occurs after 1000th imaging |
|---|---|
| Embodiment 1 | no |
| Embodiment 2 | no |
| Embodiment 3 | no |
| Embodiment 4 | no |
| Comparative example 1 | slightly |

| | Initial stage | | | After 4000th imaging | | |
|---|---|---|---|---|---|---|
| | Imaging | | | Imaging | | |
| | density | Fog | Color | density | Fog | Color |
| | (black) | density | gamut | (black) | density | gamut |
| Embodiment 1 | 1.39 | 0.000 | 100 | 1.39 | 0.001 | 99 |
| Embodiment 2 | 1.38 | 0.000 | 100 | 1.39 | 0.001 | 99 |
| Embodiment 3 | 1.39 | 0.000 | 100 | 1.39 | 0.002 | 99 |
| Embodiment 4 | 1.39 | 0.000 | 100 | 1.39 | 0.001 | 99 |
| Comparative | 1.38 | 0.000 | 100 | 1.26 | 0.010 | 87 |
| example 1 | | | | | | |

According to the results, the toner of the invention can maintain long-term stable performance.

What is claimed is:

1. A method for producing an electrostatic image developing toner comprising
a) agglutinating wax and resin particles in aqueous medium; and
b) manufacturing an electrostatic image developing toner comprising wax and resin;
wherein
said wax is disposed within colorants.
